(19) United States
(12) Patent Application Publication
(10) Pub. No.: US 2026/0073395 A1
(43) Pub. Date: Mar. 12, 2026

(54) SYSTEMS AND METHODS FOR RISK-BASED CLASSIFICATION

(71) Applicant: Protiviti Inc., Menlo Park, CA (US)

(72) Inventor: Michael Zachary Jacobs, Chicago, IL (US)

(73) Assignee: Protiviti Inc., Menlo Park, CA (US)

(21) Appl. No.: 18/826,909

(22) Filed: Sep. 6, 2024

(51) Int. Cl. G06Q 20/40; G06Q 20/06

(52) U.S. Cl. CPC G06Q 20/4016; G06Q 20/065

(57) ABSTRACT

Risk-based classification is provided. A system can identify search terms and user profiles to identify virtual asset service provider (VASP) related transactions. The system can search, using the terms, transaction data of one or more fiat service providers to identify VASP related transactions. The system can aggregate the transactions and determine metrics of the aggregated transactions. The data processing system can apply rules to the metrics and classify one or more of the aggregated transactions as one of various types of prohibited transactions.

### FIELD OF THE DISCLOSURE

This disclosure generally relates to systems and methods for classification based on a risk. For example, a high-risk transfer can be classified according to one or more predefined categories.

### BACKGROUND OF THE DISCLOSURE

Virtual assets such as Monero, Bitcoin, or Ethereum can lower barriers and costs associated with some transactions, relative to fiat transactions as may be conducted involving banks or other fiat service providers. However, such lowered barriers may, in some cases, be used to avoid consumer protections or otherwise aid in the execution of fraudulent or other prohibited transactions. For example, fiat service providers such as banks, credit unions, or credit card issuers, can implement controls to detect fraudulent transactions, but may lack adequate insight into a blockchain for virtual assets related to those transactions. Still, the fiat service providers may be exposed to virtual asset related risks via virtual asset service providers (VASPs), as may interface between blockchains or other environments for virtual assets and fiat environments. VASPs can include wallet providers, payment processors, or cryptocurrency exchanges (e.g., centralized exchanges, decentralized exchanges, or cryptocurrency automated teller machines (ATMs)).

### BRIEF SUMMARY OF THE DISCLOSURE

The present disclosure provides systems and methods for risk-based classification. A data processing system can receive search terms related to various VASPs, such as merchant identifiers, descriptions, addresses, or other fields as may be indicated by a transaction record of the fiat service provider (e.g., a data field related to a credit card transaction, wire transfer, or so forth). The data processing system can generate normalized instances of datasets corresponding to one or more user accounts, and predict risk-related classifications of transaction sets of a user. The predicted classifications may be based on user profile data (e.g., know-your customer data) in combination with the VASP related transactions. For example, an age or marital status of a customer of a fiat service provider, in combination with a total number, total value, or other metric related to VASP related transactions, can predict a set of transactions may relate to elder abuse, a romance scam, money laundering, or other prohibited activities. By establishing the correspondence between the VASPs and the fiat transaction data, the predictions can be made without interrogation of virtual asset environments such as blockchain data analysis.

In some aspects, the techniques described herein relate to a method including, identifying, by a data processing system, one or more search terms and one or more user profiles of one or more users, based on user account data, the search terms to identify virtual asset service provider (VASP) related transactions; searching, using the identified search terms, by the data processing system, fiat transaction data of one or more fiat service providers to identify one or more VASP-related transactions including the one or more fiat service providers; aggregating, by the data processing system, transactions of the fiat transaction data matching the identified search terms for each user of the one or more user profiles; determining for each user profile, by the data processing system, a plurality of metrics of the aggregated transactions, the plurality of metrics corresponding with the one or more VASP-related transactions; applying, by a rules engine of the data processing system, one or more rules to the plurality of metrics of the aggregated transactions and the one or more user profiles; and classifying, by the data processing system and responsive to the application of the one or more rules, one or more of the aggregated transactions as one of a plurality of types of prohibited transactions.

In some aspects, the techniques described herein relate to a method, further including: receiving, by the data processing system and from a first fiat service provider, a first portion of the fiat transaction data and user account data; receiving, by the data processing system and from a second fiat service provider, a second portion of the fiat transaction data and user account data; and generating by the data processing system, according to a data mapping between the first fiat service provider and the second fiat service provider, a normalized instance of the fiat transaction data and user account data, wherein the classification uses the normalized instance.

In some aspects, the techniques described herein relate to a method, further including: generating, dynamically by the data processing system, a query function using the search terms based on a detection and retrieval of an updated text corpus received from a predefined data source.

In some aspects, the techniques described herein relate to a method, further including: presenting a level of risk, via a user interface of the data processing system, the presentation including the classification and a further plurality of classifications of a further plurality of aggregated transactions, wherein: different of the plurality of types of prohibited transactions are presented according to a different color, level, or prominence; and like types of the plurality of types of prohibited transactions are co-located.

In some aspects, the techniques described herein relate to a method, further including: classifying, by the data processing system, a second one or more of the aggregated transactions as none of the plurality of types of prohibited transactions.

In some aspects, the techniques described herein relate to a method, further including: classifying, by the data processing system, a third one or more of the aggregated transactions as a second of the plurality of types of prohibited transactions.

In some aspects, the techniques described herein relate to a method, further including: presenting, by the data processing system based on the classified type of prohibited transaction, a risk recommendation. In some aspects, the method includes generating the risk recommendation based on a plurality of risk scores. For example, the data processing system can perform a network analysis of transactions between a plurality of the fiat service providers to determine at least one of the risk scores.

In some aspects, the techniques described herein relate to a method, further including: automatically performing by the data processing system, based on the classified type of prohibited transaction, a predefined set of actions correspond to the classified type of prohibited transaction.

In some aspects, the techniques described herein relate to a method, wherein the plurality of types of prohibited transactions correspond to: identity theft; a total value of the one or more VASP-related transactions exceeding a threshold; romance scams; and elder abuse.

In some aspects, the techniques described herein relate to a prohibited transaction classification system including one or more processors coupled with memory, and configured to identify one or more search terms and one or more user profiles of one or more users, based on user account data, the search terms to identify virtual asset service provider (VASP) related transactions; search, using the identified search terms, fiat transaction data of one or more fiat service providers to identify one or more VASP-related transactions including the one or more fiat service providers; aggregate transactions of the fiat transaction data matching the identified search terms for each user of the one or more user profiles; determine, for each user profile, a plurality of metrics of the aggregated transactions, the plurality of metrics corresponding with the one or more VASP-related transactions; apply, by a rules engine, one or more rules to the plurality of metrics of the aggregated transactions and the one or more user profiles; and classify, responsive to the application of the one or more rules, one or more of the aggregated transactions as one of a plurality of types of prohibited transactions.

In some aspects, the techniques described herein relate to a prohibited transaction classification system, wherein the one or more processors are configured to: receive, from a first fiat service provider, a first portion of the fiat transaction data and user account data; receive, from a second fiat service provider, a second portion of the fiat transaction data and user account data; and generate, according to a data mapping between the first fiat service provider and the second fiat service provider, a normalized instance of the fiat transaction data and user account data, wherein the classification uses the normalized instance.

In some aspects, the techniques described herein relate to a prohibited transaction classification system, wherein the one or more processors are configured to: dynamically generate a query function using the search terms based on a detection and retrieval of an updated text corpus received from a predefined data source.

In some aspects, the techniques described herein relate to a prohibited transaction classification system, wherein the one or more processors are configured to: present a level of risk, via a user interface, the presentation including the classification and a further plurality of classifications of a further plurality of aggregated transactions, wherein: different of the plurality of types of prohibited transactions are presented according to a different color, level, or prominence; and like types of the plurality of types of prohibited transactions are co-located.

In some aspects, the techniques described herein relate to a prohibited transaction classification system, wherein the one or more processors are configured to: classify a second one or more of the aggregated transactions as none of the plurality of types of prohibited transactions.

In some aspects, the techniques described herein relate to a prohibited transaction classification system, wherein the one or more processors are configured to: classify a third one or more of the aggregated transactions as a second of the plurality of types of prohibited transactions.

In some aspects, the techniques described herein relate to a prohibited transaction classification system, wherein the one or more processors are configured to: present, based on the classified type of prohibited transaction, a risk recommendation.

In some aspects, the techniques described herein relate to a prohibited transaction classification system, wherein the one or more processors are configured to: automatically perform, based on the classified type of prohibited transaction, a predefined set of actions correspond to the classified type of prohibited transaction.

In some aspects, the techniques described herein relate to a prohibited transaction classification system, wherein the plurality of types of prohibited transactions correspond to: identity theft; a total value of the one or more one or more VASP-related transactions exceeding a threshold; romance scams; and elder abuse.

In some aspects, the techniques described herein relate to a non-transitory computer-readable media including computer-readable instructions stored thereon that, when executed by at least one processor of a data processing system, cause the at least one processor to: identify one or more search terms and one or more user profiles of one or more users, based on user account data, the search terms to identify virtual asset service provider (VASP) related transactions; search, using the identified search terms, fiat transaction data of one or more fiat service providers to identify one or more VASP-related transactions including the one or more fiat service providers; aggregate transactions of the fiat transaction data matching the identified search terms for each user of the one or more user profiles; determine, for each user profile, a plurality of metrics of the aggregated transactions, the plurality of metrics corresponding with the one or more VASP-related transactions; apply, by a rules engine, one or more rules to the plurality of metrics of the aggregated transactions and the one or more user profiles; and classify, responsive to the application of the one or more rules, one or more of the aggregated transactions as one of a plurality of types of prohibited transactions.

In some aspects, the techniques described herein relate to a computer-readable media, further including instructions to cause the at least one processor to: receive, from a first fiat service provider, a first portion of the fiat transaction data and user account data; receive, from a second fiat service provider, a second portion of the fiat transaction data and user account data; and generate, according to a data mapping between the first fiat service provider and the second fiat service provider, a normalized instance of the fiat transaction data and user account data, wherein the classification uses the normalized instance.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is a block diagram depicting a data processing system interfacing with related systems, in accordance with some embodiments.

FIG. 3 is a flow diagram for data aggregation or normalization, in accordance with some embodiments.

FIG. 4 is a dataflow for generating a result set of fiat transactions related to virtual assets, in accordance with some embodiments.

FIG. 5 is a block diagram of a transaction classification dataflow, in accordance with some embodiments.

FIG. 6 is a flowchart of a method of risk-based classification, in accordance with some embodiments.

FIG. 7 is a user interface providing data related to risk-based classification, in accordance with some embodiments.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for risk-based classification.

### A. Computing and Network Environment

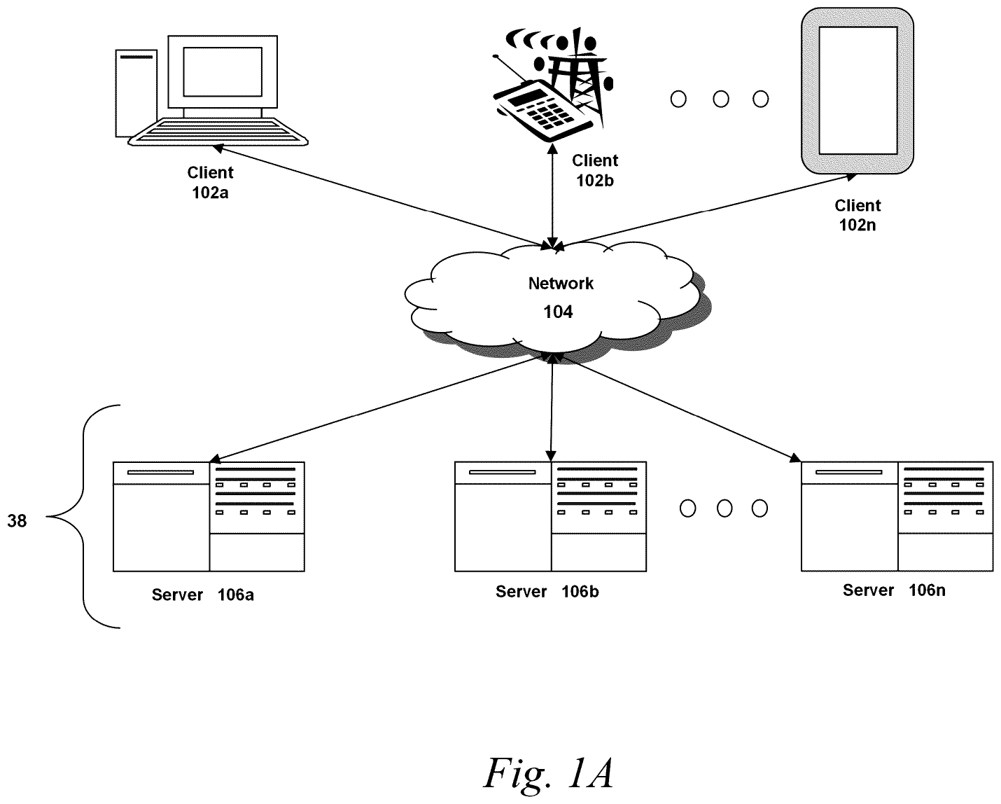

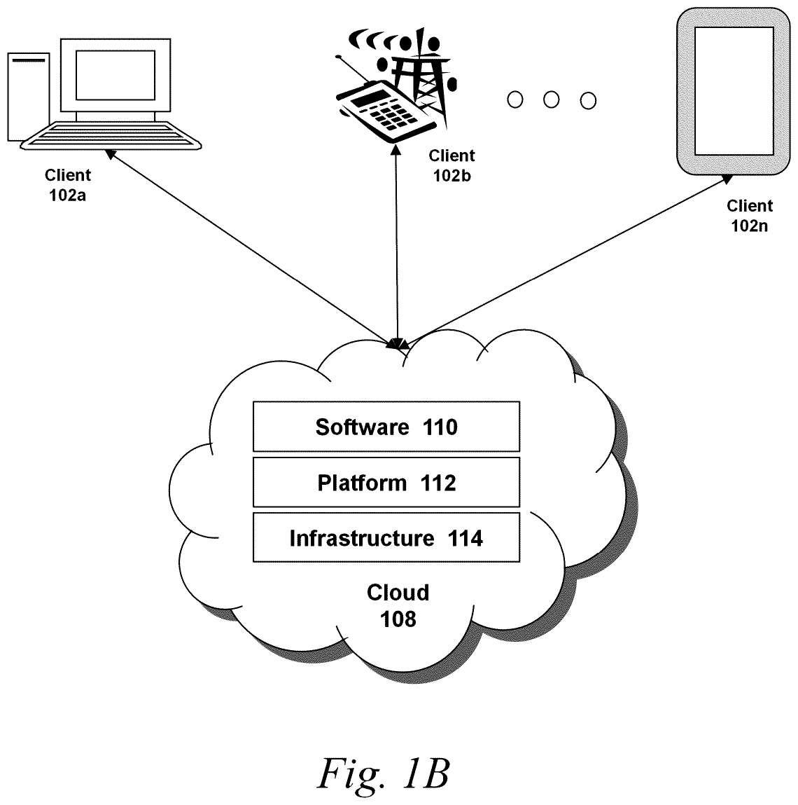

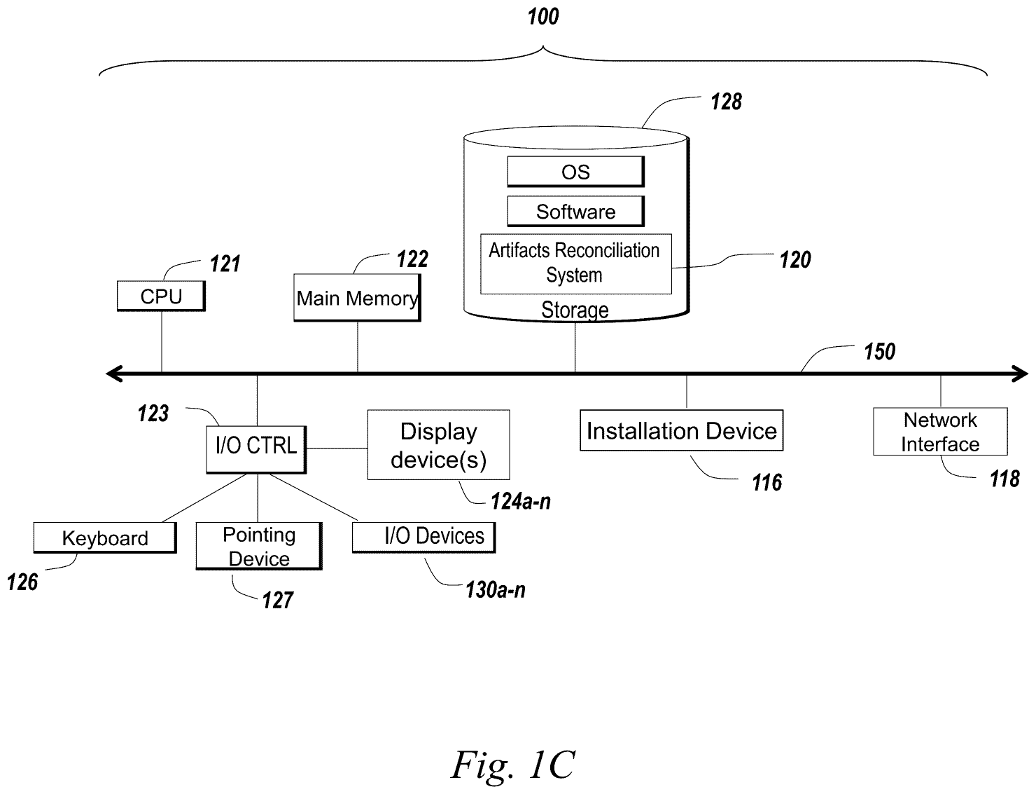

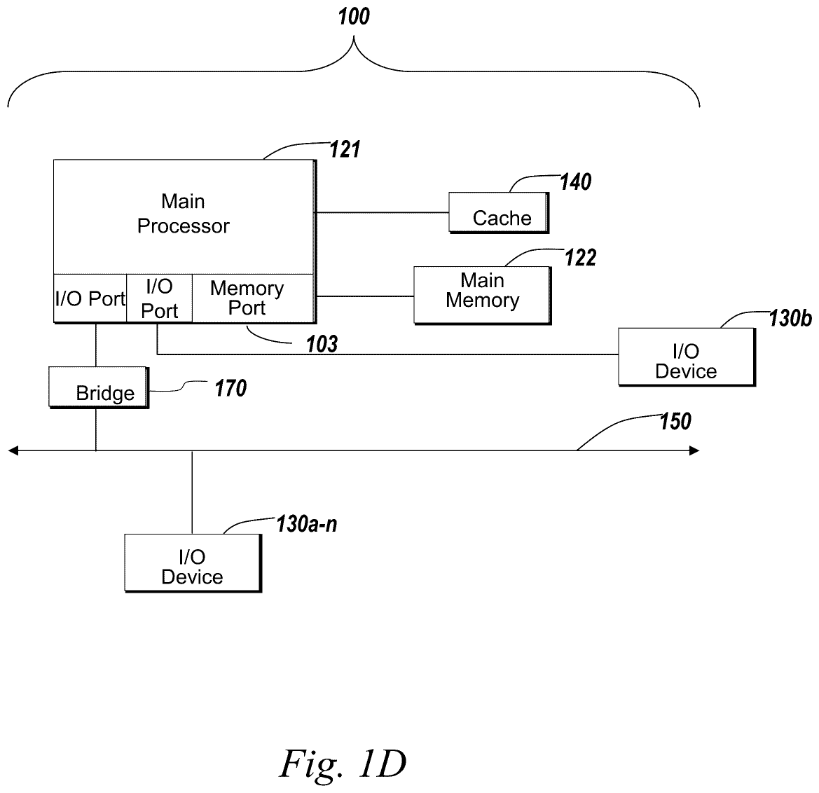

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Washington), while one or more of the other servers 106 can operate on according to another type of operating system platform (e.g., Unix, Linux, or Mac OS X).

In some embodiments, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, California; the Xen hypervisor, an open-source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In some embodiments, the server 106 may be referred to as a remote machine or a node. In another embodiment, a plurality of nodes 106 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back-end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g., a mouse. The storage device 128 may include, without limitation, an operating system, software, and a software of a data processing system 200. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to, and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g., a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In some embodiments, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in some embodiments, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116, and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In some embodiments, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. of Ft. Lauderdale, Florida. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Washington.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g., the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g., the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In some of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Risk-Based Classification

Systems and methods of the present solution are directed to risk-based classification of transactions related to a virtual asset service provider (VASP). Risk-based classification may refer to or include a classification of one or more transactions according to a particular type of prohibited transaction, such as by generating a risk score for each of the one or more particular prohibited transaction types, and comparing the risk score to at least one threshold.

The systems and methods of the present disclosure can classify VASP-related transactions based on fiat-based transaction data, as opposed to virtual asset-based transactions. Such determinations can avoid certain complexities as may be present in blockchains or other virtual asset environments. For example, virtual asset environments can include numerous currencies and transfers within or between the currencies. These transfers can include transfers intended to obscure their source (e.g., coin tumblers). Further, while some currencies, such as bitcoin or Ethereum may include public ledgers, other currencies (e.g., Monero) include strong privacy features. Fiat transactions, by contrast, are generally performed with regard to known parties (e.g., known institutions or clients described by know-your-customer (KYC) data). Virtual asset related transaction may be evidenced by involvement of VASPs, such as exchanges or bitcoin ATMs (or related intermediaries), and may indicate risk. However, identifying, aggregating, and analyzing these transactions for indications of risk may be challenging. For example, VASPs may not adhere to standardized transaction data records; some VASPs may intentionally obscure a source or use.

A fiat service provider (FSP) such as a bank may identify one or more fraudulent or other prohibited transactions, such as transactions related to identity theft, money laundering (e.g., money muling), romance scams, elder abuse, or so forth. Such determinations may be aided, or based on transaction data for transactions with a VASP.

A data processing system can be configured to identify any VASP related transactions. The identification may be accomplished via a classification of a particular prohibited type of transaction. The data processing system can classify the transactions based on user account data, including the KYC data. The data processing system includes various components, any of which may be hardware or software components. The components of the data processing system may be co-located or remote from one another and may be communicatively coupled with other components. The components of the data processing system may be in network communication with various VASPs, or information related to the various VASPs. Information related to the VASPs can include private sources, such as transaction data provided by the VASP, or from related entities. Information related to the VASPs can include public sources, such as scraped data from various monitored locations accessible via open web or dark web protocols.

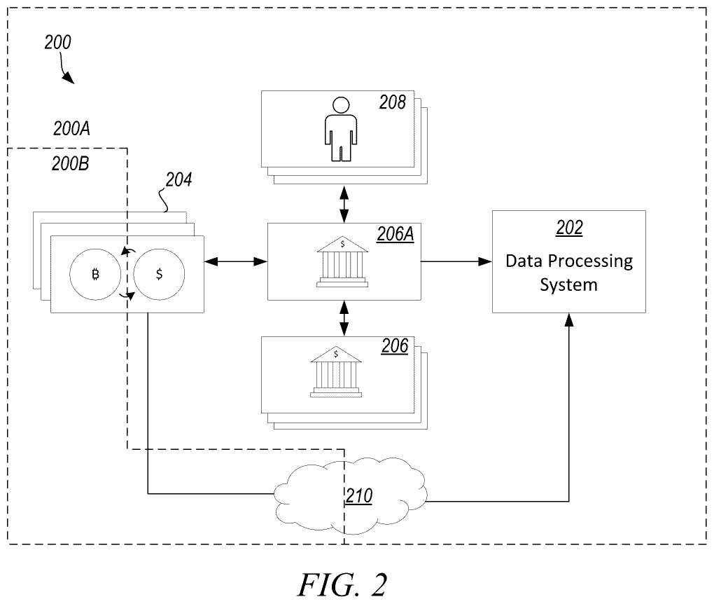

FIG. 2 is a block diagram depicting a data processing system 202 interfacing with related systems, in accordance with some embodiments. The various depicted systems are provided as disposed within an environment 200.

The environment 200 includes at least one virtual asset service provider (VASP) 204, as well as at least one fiat service provider (FSP) 206. At least a first 206A of the FSPs is communicatively coupled with the data processing system 202. In some embodiments, various of the depicted FSPs 206 may each be communicatively coupled with the data processing system 202. The VASPs 204 interface between a virtual (e.g., blockchain) portion 200A of the environment 200 and a fiat portion 200B of the environment 200. Virtual assets of the virtual environment 200B can include, for example, cryptocurrencies, such as Bitcoin, Ethereum, Monero, and so forth.

Some VASP transactions may occur within the virtual portion 200B of the environment 200. For example, an exchange between Bitcoin and Ethereum, or a transfer of a cryptocurrency between accounts can occur without interfacing with an FSP 206. Virtual portions of financial networks can include substantial complexity, or may not be publicly accessible, in some circumstances. Accordingly, managing virtual asset-related risks can prove impractical within the virtual environment 200B. However, VASPs 204 frequently interface with FSPs 206 to interface with fiat currencies. The FSP 206 can include a bank, credit union, credit card issuer, or other regulated financial institution which transacts in a fiat currency such as dollars, euros, or rubles. For example, credit card purchases of virtual currencies, wires or automatic clearing house (ACH) transfers related to the purchase or sale of virtual assets, or other transactions can include an FSP 206 as a party, counterparty, intermediary, or facilitator (e.g., a credit card issuer/acquirer or depository institution).

Each FSP 206 can maintain accounts for various users 208 (e.g., customers or trustees). The FSP 206 can maintain, for each account, transaction data such as lists of transactions including transaction times, transaction amounts, parties and counterparties to the transactions, transaction descriptions, merchant codes, or other transaction data. Further, the FSP 206 can maintain user account data associated with the various accounts, including user profile data related to customers or other users 208. For example, the user profile data can include names, addresses, or other identifiers for users 208. Some of this data may include or be referred to as know your customer (KYC) data, as may correspond to data items of a regulatory schema.

The data processing system 202 may be communicatively coupled with at least the first 206A of the FSPs, any may, in some embodiments, be communicatively coupled with further of the FSPs 206. The data processing system 202 may receive transaction lists, KYC data, or other data from various of the FSPs 206. The data processing system 202 may be configured to normalize any received data. The data processing system 202 can generate datasets based on the information received from the multiple FSPs 206, as may improve detection of VASP-related transactions. For example, the data processing system 202 can determine that a fiat transfer to the first 206A of the FSP is VASP-related based on transaction data received from a source account at another of the FSPs 206 indicating transfers with at least one VASP 204. In some embodiments, the data processing system 202 can determine relationships between accounts based on transactions therebetween or KYC data of the various FSP 206.

The data processing system 202 can further receive, via nodes of a network 210, data relating to the various VASPs 204. Such a network 210 can include a direct communications channel with the VASPs 204 themselves, related entities, or other private data sources. Such sources may be referred to as private nodes. In some embodiments, the data received from the network 210 can be data extracted from a set of public locations (which may be referred to as public nodes). For example, the data processing system 202 can scrape data from publicly accessible nodes on the open or dark web. Such information can include an identity of various VASPs 204, such as a description field of transaction data, or other associated data (e.g., a merchant identifier, address, description field, or address). For example, a description field can include a format or identifier (e.g., address) which indicates a VASP transaction.

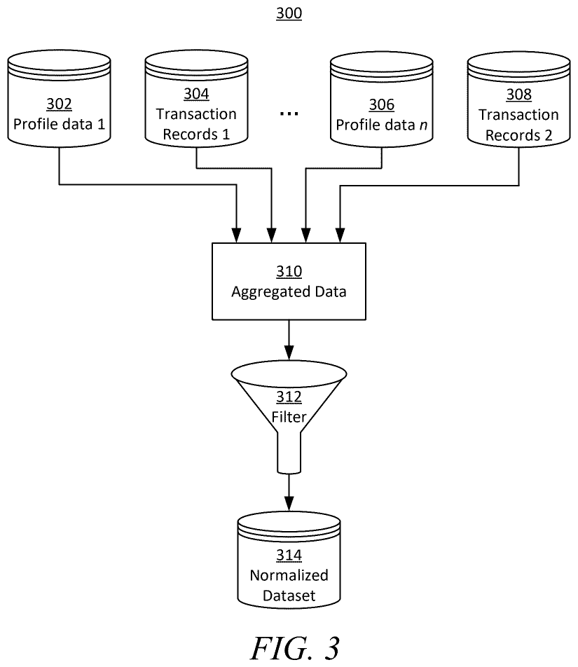

FIG. 3 depicts a flow diagram 300 for data aggregation or normalization, according to some embodiments. The various operations of the depicted data flow can be performed in various sequences, according to various embodiments of the present disclosure.

A data processing system 202 can receive data structures from one or more FSP 206. The data sources can each include at least one database, table, or other data structure. Depicted are illustrative examples of a first data structure 302 corresponding to user profile data associated with user accounts, and a second data structure 304 corresponding to transaction records as may be related to the user profiles. The first data structure 302 and second data structure 304 can correspond to a first FSP 206. Further data structures may relate to further FSPs 206. Depicted are illustrative examples of a third data structure 306 including profile data of the at least one further FSP 206, and a fourth data structure 308 including transaction records from the at least one further FSP 206.

The data structures (e.g., data items thereof) may vary between various embodiments of the present disclosure, or between various FSPs 206 of a particular embodiment. For example, a FSP 206 can include separate data structures relating to ACH transactions, credit/debit card transactions, bank transfer transactions, check transactions, and so forth. Another FSP 206 can include separate data structures relating to checking accounts, savings accounts, credit card accounts, or other accounts. Further, various data structures can include data fields provided according to different formats. For example, one data structure can include a name formatted as a string of “John Smith.” Another data structure, of a same or different FSP 206, can include a first_name field of “John” (or variants thereof, such as “john,” “JOHN,” “Jon” or “Jonathan”) and a last_name field of “Smith.”

In some embodiments, the various of the data structures are generated responsive to queries generated by the data processing system 202. In some embodiments, the data processing system 202 can generate or otherwise receive the data structures. The data processing system 202 can generate, using the various input data structures, aggregated data 310. For example, the data processing system 202 can generate an aggregated data structure according to a predefined relationship between various input data structures (e.g., a concatenation of strings of “John” and “Smith” to form a string of “John Smith.”) Further data elements may be generated, inferred or otherwise normalized.

The data processing system 202 can apply filters 312 to generate the various data structures prior to aggregation or, as depicted, apply filters 312 to aggregated data 310. That is, in some embodiments, data elements of a data structure may be filtered prior to generation of a normalized data structure. Further, related operations, such as string cleansing operations (e.g., for a payment description field) may be performed for the data flow.

A filter 312 can refer to a logical exclusion of certain data items of an input data structure. For example, the filter can select a transaction amount, merchant identifier, time period (e.g., previous ninety days, quarter, month, day, or so forth), or a user/customer group (e.g., according to a location, age, marital status, recent change in residence, etc.). In some embodiments, the filter 312 may be applied according to a generation of a query or be applied to query results. For example, the data processing system 202 can generate a query or subsequent filter 312 to retrieve transaction data in the last three months corresponding to a user profile for users 208 exceeding sixty-five years old and residing in a particular set of zip codes.

As indicated above, like other operations of the dataflow, the filtering can be performed prior or subsequent to other operations. For example, filtering may be performed prior to aggregation so as to generate a data structure including a predefined set of data fields. A filter output (or the aggregated data 310, in embodiments omitting post-aggregation filters 312), may be referred to as a normalized dataset 314, including normalized information from at least two data sets received by the data processing system 202.

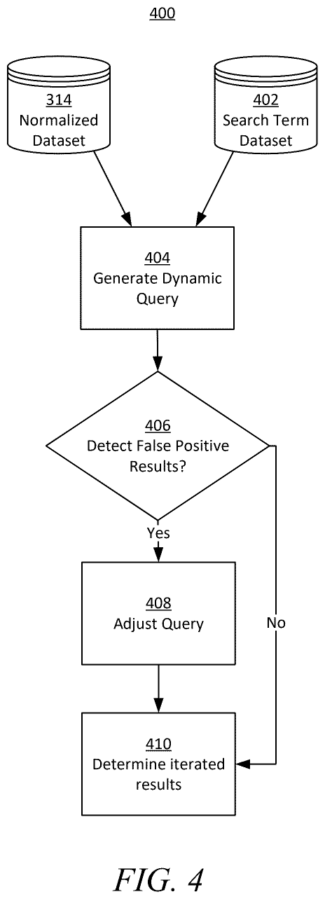

FIG. 4 depicts a dataflow 400 for generating a result set of fiat transactions related to virtual assets (e.g., based on an association with a VASP 204), according to some embodiments. A data processing system 202 can generate the result set by matching any of various search terms or other flags of a search term dataset 402 with a normalized dataset, such as the normalized dataset 314 generated according to the data flow of FIG. 3.

Referring further to the search term dataset 402, the search term dataset 402 can include data elements for various search terms. The search terms can include indicia of a VASP 204, or flags indicative of a risk (e.g., a risk corresponding to a particular type of prohibited transaction). The search term dataset 402 can include the data elements as received from various sources. For example, some data elements may be received from a VASP 204 or other private node to indicate a format, merchant code, or other indication that a transaction may be related to a particular VASP 204. Other data elements may be received from nodes of the network 210 via automated data extraction (e.g., web scaping) from public or private nodes.

The public or private nodes can include dump files related to compromised information, such as names, social security number or other identification as may correspond to user account information of the normalized dataset 314 (e.g., as may itself be sourced from the first data structure 302 of FIG. 3). The public nodes can include open web sources, as may be accessible via hypertext transfer protocols, or dark web sources as may be accessible via the Onion Router (TOR), or other privacy-focused protocols. In some embodiments, the nodes can include aggregated data as may be provided by at least one FSP 206. For example, the FSP 206 can provide a risk-based lists of merchants or locations, or association of particular prohibited transaction types associated with user profile data.

The data elements can include indications of a VASP 204 such as transaction identifiers thereof (e.g., identifying various centralized exchanges, ATMs, or other VASPs 204 that may transact directly with customers). In some embodiments, the data elements may uniquely identify a particular VASP 204; in some embodiments, the data elements may indicate correspondence to a presence of a VASP 204 generally.

The data processing system 202 can extract and generate search terms from the extracted data elements according to tokens or variants thereof. For example, “coinbase” can be tokenized to form tokens of “coin” and “base” to match with recitations of “coinbase” coin base” or so forth. In some embodiments, the data processing system 202 is configured to generate the variations according to various natural language processing (NLP) techniques.

The data processing system 202 can generate risk indicators (e.g., flags or scores) related to extracted or generated search terms. For example, the risk flags or score can indicate (or be based upon) a correlation between a search term and an exchange based in a country under sanctions, another non-conforming entity. For example, the data processing system 202 can receive and store an indication that a particular centralized exchange VASP 204 accepts fiat currency or virtual assets associated with a particular prohibited transaction type (e.g., Won, Rubles, Monero, etc.). Thereafter, upon detection of transaction data related to the VASP 204, the data processing system 202 can determine a risk score for the prohibited transaction type based on the inclusion of the VASP 204. That is, the search term dataset 402 can include the various extracted data elements corresponding to indicia of risk.

Referring now to operation 404, the data processing system 202 generates a query to match instances of the normalized dataset 314 with the search term dataset 402. The matches can include matches related to transaction data such as a party, counterparty, location, or so forth. For example, the match can determine that a transaction involves a VASP 204, or compromised user account information (e.g., name, social security number, password, etc.). The match can be determined according to a literal match of a string (or other value, such as an integer), or according to various NLP techniques. In some embodiments, a match score is generated based on various criteria and compared to a threshold to determine the presence of a match. In some embodiments, the query is generated dynamically. For example, the data processing system 202 can generate the query according to updated terms of the normalized dataset 314 and the search term dataset 402 (which the data processing system 202 can update according to data extracted from the various nodes in network communication with the data processing system 202).

Referring now to decision block 406, the data processing system 202 can identify false positive matches. False positive matches can refer to matches which do not correspond to a risk for a particular prohibited transaction type. In some embodiments, the data processing system 202 can identify false positive matches according to further data of the normalized dataset (e.g., a merchant identifier, address, or so forth). In some embodiments, the data processing system 202 can identify the false positive matches according to an input received via a user interface (e.g., a response to a prompt generated by the data processing system 202).

Referring now to operation 408, the data processing system 202 can adjust the query. In some embodiments, the adjustment of the query includes a removal or modification of a data element of the search term dataset 402 based on a number of false positive matches associated with a search term data element of the search term dataset 402. In some embodiments, the data processing system 202 can remove or modify the search term based on a number or proportion of matches exceeding a threshold. In some embodiments the data processing system 202 can generate a flag for matches with a search term associated with a high level of false positives.

Referring now to operation 410, the data processing system 202 can determine the result set. For example, the data processing system 202 can determine the result set according to a number, proportion, or other metric of false positive results at decision block 406. According to various ingested data, the data processing system 202 can proceed to operation 410 subsequent to any number of executions of decision block 406 or operation 408. For example, in some embodiments, the data processing system 202 may omit operation 408 according to the false positive results determined at a first instance of decision block 406.

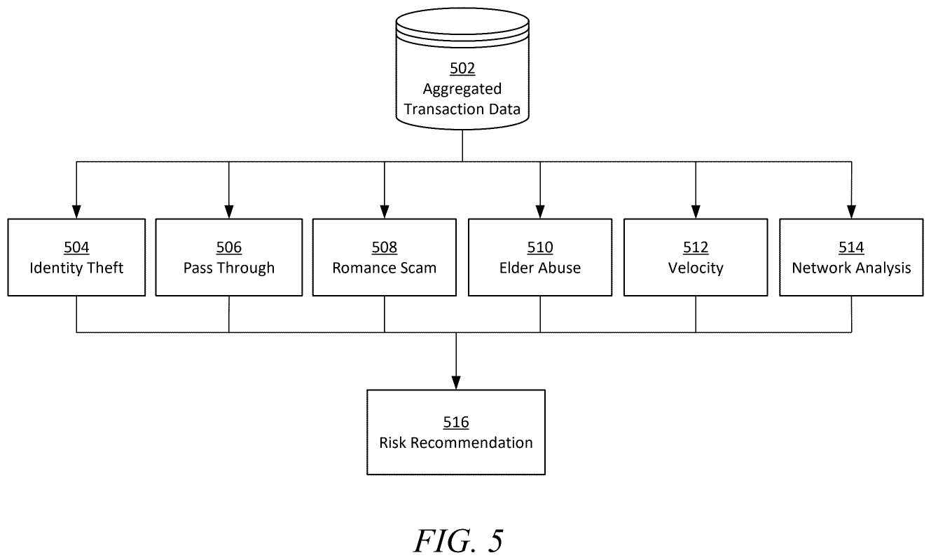

FIG. 5 is a block diagram 500 of a transaction classification dataflow, in accordance with some embodiments. For example, the data processing system 202 can determine metrics associated with various of the transactions and apply a rules engine to the metrics of the transactions.

The aggregated transaction data 502 can refer to the iterated results of operation 410, or any derivatives thereof. For example, the data processing system 202 can determine various metrics from the iterated results to generate metrics of the aggregated transaction data 502. To generate the metrics, the data processing system 202 can group transactions according to a name, account number, social security number, or other index value corresponding to a user profile.

The data processing system 202 can determine, based on the grouped transactions, metrics such as a number of VASP-related transactions, a sum of a value of the VASP-related transactions, a number of different VASP entities 204 transacted with, or a number of transactions related to a particular risk flag or score. In some embodiments, the data processing system 202 can generate or scale metrics according to a quantity, value, or proportion of non-VASP or risk-related transactions of a same account. For example, an account with VASP-related transactions totaling thousands of dollars may be less indicative of risk for an account with non-VASP related transaction velocity in the millions of dollars, than for an account with non-VASP related transaction velocity in the hundreds of dollars.

In some embodiments, any of the metrics may be provided as filtered over a time or other period such as a past three months, a past one-hundred transactions, or so forth. For example, the data processing system 202 can determine metrics based on predefined periods based on dates or other indicators provided from a normalized dataset 314, or according to a filter 312 applied to generate the data of the normalized dataset 314.

The data processing system 202 executes a rules engine based on at least the metrics of the aggregated transaction data 502. For example, the data processing system 202 can determine a score corresponding to each of various types of prohibited transactions. A non-limiting list of some examples of risk scores which the data processing system 202 can generate, include an identity theft risk score 504, pass-through transaction risk score 506 (e.g., money muling or other straw-transactions), romance scam risk score 508, elder abuse risk score 510, or a total financial velocity risk score 512 (e.g., a speed or frequency at which value moves through an account).

In some embodiment, the data processing system 202 can execute the rules engine to determine a score for a prohibited transaction type according to a network analysis 514 of the transaction data. The network analysis 514 can trace flows between various of the FSPs 206. For example, the data processing system 202 can model a network having nodes corresponding to various FSPs 206, users 208, user accounts, and edges corresponding to transactions (e.g., transfers) therebetween.

In some embodiments, the data processing system 202 can execute the network analysis 514 based on either of the metrics or individual transactions. In some embodiments (as is depicted), the data processing system 202 can generate a risk score related the network analysis 514, such that an anomalous network flow may be provided as a prohibited transaction type. In some embodiments, the data processing system 202 can perform a network analysis 514 incident to a generation of further of the risk scores. For example, the data processing system 202 can determine an identity theft risk score 504, pass-through transaction risk score 506, romance scam risk score 508, elder abuse risk score 510, or a total financial velocity risk score 512 based on the network analysis 514. In some embodiments, the data processing system 202 can determine that an account, user, or transaction of the account or user is VASP-related based on the network analysis 514 (e.g., that a transaction between accounts exhibiting transaction flow patterns involving VASPs 204 is itself a VASP-related transaction).

The data processing system 202 can classify a set of transactions according to a particular type of prohibited transaction (e.g., VASP-related transactions or transactions corresponding to a same account). The classification may be provided as a risk recommendation 516. To determine the risk recommendation 516, the data processing system 202 can compare one or more risk scores to a threshold, or to each other. For example, where a risk score for identity theft 504 and romance scam 508 both exceed corresponding thresholds, the data processing system 202 can compare risk scores to one other. For example, where a risk score for identity theft 504 equals 0.8 and a risk score for a romance scam 508 is 0.7 the data processing system 202 can generate a risk recommendation 516 for a prohibited transaction type of identity theft.

In some embodiments, the data processing system 202 can automatically perform an action responsive to the risk recommendation 516. For example, the data processing system 202 can generate a text message, place holds on accounts, or perform further automated actions. In some embodiments, the data processing system 202 can present the risk recommendation 516 via a user interface or other communications interface.

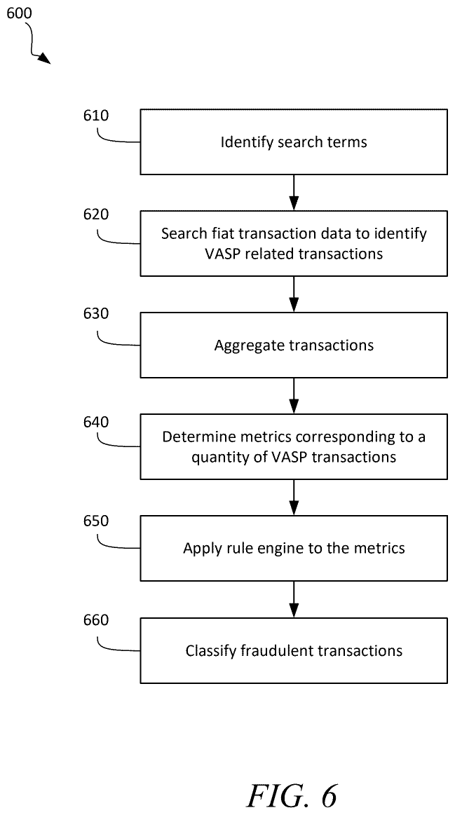

FIG. 6 is a flowchart of an example method 600 of risk-based classification, in accordance with some embodiments. The method 600 may be used to determine, indicate, or respond to indications of prohibited activity involving an FSP 206. For example, the method 600 may be performed with respect to various users 208 or accounts of a bank or other financial institution. The method 600 is disclosed as a non-limiting example; additional operations may be provided before, during, or after the various operations of the method 600. Further, some operations may only be described briefly herein, however, the operations may be performed in conjunction with other aspects of risk-management, including those provide herein.

In brief summary, a data processing system 202 identifies search terms at operation 610. At operation 620, the data processing system 202 searches fiat transaction data to identify VASP related transactions. The data processing system 202 aggregates the VASP-related transactions at operation 630. The data processing system 202 determines metrics corresponding to the VASP-related transactions at operation 640. The data processing system 202 applies a rule engine to the metrics at operation 650. At operation 660, the data processing system 202 classifies prohibited transactions (to include transactions based on an association with a user or account) according to a type of prohibited conduct.

Referring to operation 610, the data processing system 202 identifies search terms to identify VASP-related transactions. For example, the data processing system 202 can generate search terms based on extracted data (e.g., web scraping from open web or dark web sources). The data processing system 202 can further identify at least one user profile of at least one user 208. For example, the user profile can correspond to a set of fiat transaction data. In some embodiments, the at least one user profile can include various user profiles associated with at least one fiat service provider (e.g., a financial institution). The various user profiles can include KYC information of user account data associated with the various users 208. For example, the KYC information can include a name, address, social security number or other tax identification number, address, occupation, employment or other source of funds, income level, marital status, and so forth.

In some embodiments, the data processing system 202 receives respective first and second portions of the fiat transaction data and user account data from separate sources, such as first and second fiat service providers, or first and second data structures of a same fiat service provider. The data processing system 202 can generate a normalized instance of the fiat transaction data and user account data based on a data mapping between the respective data structures (e.g., between the respective fiat service providers).

Referring to operation 620, the data processing system 202 searches, using the identified search terms, fiat transaction data of one or more fiat service providers to identify one or more VASP-related transactions including the one or more fiat service providers. In some embodiments, the data processing system 202 generates a query of the search dynamically. For example, the data processing system 202 can generate the query based on a detection and retrieval of an updated text corpus received from a predefined data source (e.g., scraped from a public or private node of a network 210).

Referring to operation 630, the data processing system 202 aggregates transactions of the fiat transaction data matching the identified search terms for each user 208 of the one or more user profiles. The data processing system 202 may identify all VASP-related transactions according to such aggregation. In some embodiments, the one or more user profiles can include every profile for a FSP 206, such that the present method may be executed on an institutional basis to determine various measures of risk. Moreover, a user interface can present risk contributors related to a sum (e.g., selected accounts or users of the FSP 206 contributing to the risk).

Referring to operation 640, the data processing system 202 determines, for each user profile, metrics of the aggregated transactions, the plurality of metrics corresponding with the one or more VASP-related transactions. Although the various metrics rely on a quantity of, or other attributes of the various VASP-related transactions, the data processing system 202 may further generate the metrics based on non-VASP related transactions, in some embodiments. For example, a metric can relate to a proportion of a value or quantity of VASP-related transaction to non-VASP-related transactions, or total transactions for an account, a user 208, or other groupings of transaction data.

Referring to operation 650, the data processing system 202 applies a rules engine implementing one or more rules to the plurality of metrics of the aggregated transactions and the one or more user profiles. For example, the execution of the rules engine can generate a risk score, or determine various risk recommendations 516. Each risk score corresponds to a particular type of prohibited transaction. Accordingly, the risk recommendation 516 may be tailored to the particular type of prohibited transaction. For example, a risk recommendation 516 can include prompt notification of a user 208 for some prohibited transaction types (e.g., identity theft) but such action may be counter-indicated by others, pending further investigation or notifications.

Referring to operation 660, the data processing system 202 classifies, responsive to the application of the one or more rules, one or more of the aggregated transactions as one of a plurality of types of prohibited transactions. The prohibited transaction types can include, for example, identity theft, a total value of the one or more of the transactions exceeding a threshold or other velocity metrics, pass-through transactions, romance scams, or elder abuse.

In some embodiments, the data processing system 202 is configured to determine a prohibited transaction type on an account or user basis, such that the one or more aggregated transactions can include every transaction associated with the account or the user 208. In some embodiments, a portion of the aggregated transactions are classified as none of the prohibited transactions (e.g., a non-prohibited transactions), or as a further (different) type of prohibited transaction. For example, the data processing system 202 can classify one portion of the transactions as pass-through transactions, another portion of the transactions as violating a velocity threshold, and a further portion of the transactions as non-prohibited. In some embodiments, some transactions may be included in multiple classifications (e.g., the identity theft transactions may be included in the total velocity of transactions).

In some embodiments, the data processing system 202 is configured to present a level of risk via a user interface, such as a display of a GUI or a report generated and output by the data processing system 202. For example, the presentation can include the classification and a further plurality of classifications of a further plurality of aggregated transactions (e.g., transaction corresponding to a plurality of other users 208, other accounts, or other information as may be provided via a risk dashboard for an FSP 206. The different types of prohibited transactions may be presented according to a different color, level, or prominence. Like types of the plurality of types of prohibited transactions may be co-located, combined (e.g., in an aggregate field), or nested. In some embodiments, the user interface can provide control elements to select and deselect constituent elements of the transactions, users 208, accounts, or so forth.

In some embodiments, the data processing system 202 can present the risk recommendation 516 determined at operation 650, for at least one classified type of prohibited transaction. For example, the risk recommendation 516 may be provided as a selectable element configured to implement the recommendation corresponding to the prohibited transaction type. In some embodiments, the data processing system 202 automatically performs a predefined set of actions corresponding to the classified type of prohibited transaction. For example, the predefined set of actions can include transmitting a notification to a user 208 of a risk, transmitting a notification of the risk to another party (e.g., to report suspicious activity to a regulatory or enforcement body), prompting a user 208 to provide a confirmation of a transaction, limiting account transactions, or so forth.

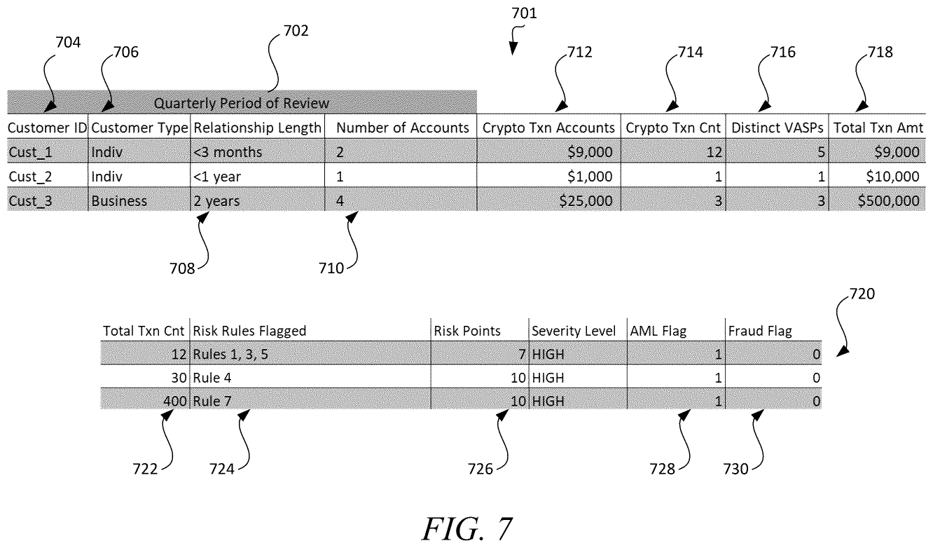

FIG. 7 is a user interface 700 providing data related to risk-based classification, in accordance with some embodiments. The depicted view should not be construed as limiting. Various further data may be presented, or data may be presented according to further views, some illustrative examples of which are described above.

The user interface 700 includes a first view 701. Although the depicted view 701 is depicted on a user basis, such a view 701 should not be constrained as limiting. For example, according to some views of the user interface 700, the user interface 700 can present data on an account or other basis. For example, a second view 720 provides data organized on an FSP basis. The data of the user interface 700 may be received as filtered according to a data processing query or other filter 312. For example, the depicted data can correspond to a temporal period 702 (depicted as three months, though such a period may vary according to a user selection or various embodiments). Further depicted are various users 704, corresponding to user types 706 (e.g., individual account holders or businesses). Further displayed information can include a relationship length 708, number of accounts 710, total VASP-related transactions 712, counts of those transactions 714, number of VASPS transacted with 716, and a total transaction amount of VASP and non-VASP transactions 718.

Referring again to the second view 720, information related to a FSP 206 is provided. Particularly, a transaction count 722 related to risk rules 724 of the rule engine are provided. Each risk rule 724 can correspond to a risk score 726; a further score can indicate a probability or match score for one or more flag (not depicted). Further, each risk rule 724 can correspond to one or more flags (e.g., anti-money laundering flags 728, fraudulent activity flags 730, or so forth).

While the invention has been particularly shown and described with reference to specific embodiments, it should be understood by those skilled in the art that various changes in form and detail may be made therein without departing from the spirit and scope of the invention described in this disclosure.

Various descriptions, herein, make use of the word “or” to refer to plurality alternative options. Such references are intended to convey an inclusive or. For example, various data processing system components herein are referred to as hardware or software components. Such a disclosure indicates that the components may comprise a hardware component, a software component, or both a hardware and software components.

1. A method comprising,
generating, dynamically by a data processing system, a query function using search terms to identify virtual asset service provider (VASP) related transactions generated based on a detection and retrieval of an updated text corpus received from a predefined data source, wherein dynamically generating the query function comprises detecting an update notification or change event indicating availability of a revised text corpus at the predefined data source, responsive to which the data processing system regenerates the query function;
identifying, by the data processing system, one or more of the search terms and one or more user profiles of one or more users, based on user account data;
searching, using the identified search terms, by the data processing system, fiat transaction data of one or more fiat service providers to identify one or more VASP-related transactions including the one or more fiat service providers;
aggregating, by the data processing system, transactions of the fiat transaction data matching the identified search terms for each user of the one or more user profiles;
determining for each user profile, by the data processing system, a plurality of metrics of the aggregated transactions, the plurality of metrics corresponding with the one or more VASP-related transactions;
applying, by a rules engine of the data processing system, one or more rules to the plurality of metrics of the aggregated transactions and the one or more user profiles; and
selecting, according to a classification of the data processing system and responsive to the application of the one or more rules, which one type of a plurality of types of prohibited transactions correspond to the one or more of the aggregated transactions.

2. The method of claim 1, further comprising:
receiving, by the data processing system and from a first fiat service provider, a first portion of the fiat transaction data and user account data;
receiving, by the data processing system and from a second fiat service provider, a second portion of the fiat transaction data and user account data; and
generating by the data processing system, according to a data mapping between the first fiat service provider and the second fiat service provider, a normalized instance of the fiat transaction data and user account data, wherein the classification uses the normalized instance.

3. The method of claim 1, further comprising:
generating the query function using a current set of search terms and token variants.

4. The method of claim 1, further comprising:
receiving, from a plurality of control elements of a user interface, a selection of constituent elements of the aggregated transactions, the one or more users, and accounts for the account data;
presenting a level of risk, via a user interface of the data processing system, the presentation comprising the classification and a further plurality of classifications of a further plurality of aggregated transactions based on the selected ones of the aggregated transactions, the one or more users, and accounts, wherein:
different of the plurality of types of prohibited transactions are presented according to a different color, level, or prominence; and
like types of the plurality of types of prohibited transactions are co-located.

5. The method of claim 1, further comprising:
classifying, by the data processing system, a second one or more of the aggregated transactions as none of the plurality of types of prohibited transactions.

6. The method of claim 5, further comprising:
classifying, by the data processing system, a third one or more of the aggregated transactions as a second of the plurality of types of prohibited transactions.

7. The method of claim 1, further comprising:
presenting, by the data processing system based on the classified type of prohibited transaction, a risk recommendation.

8. The method of claim 1, further comprising:
automatically performing by the data processing system, based on the classified type of prohibited transaction, a predefined set of actions correspond to the classified type of prohibited transaction.

9. The method of claim 1, wherein the plurality of types of prohibited transactions correspond to:
identity theft;
a total value of the one or more VASP-related transactions exceeding a threshold;
romance scams; and
elder abuse.

10. A prohibited transaction classification system comprising one or more processors coupled with memory, and configured to:
dynamically generate a query function using search terms to identify virtual asset service provider (VASP) related transactions generated based on a detection and retrieval of an updated text corpus received from a predefined data source, wherein dynamically generating the query function comprises detecting an update notification or change event indicating availability of a revised text corpus at the predefined data source, responsive to which the data processing system regenerates the query function;
identify one or more of the search terms and one or more user profiles of one or more users, based on user account data;
search, using the identified search terms, fiat transaction data of one or more fiat service providers to identify one or more VASP-related transactions including the one or more fiat service providers;
aggregate transactions of the fiat transaction data matching the identified search terms for each user of the one or more user profiles;
determine, for each user profile, a plurality of metrics of the aggregated transactions, the plurality of metrics corresponding with the one or more VASP-related transactions;
apply, by a rules engine, one or more rules to the plurality of metrics of the aggregated transactions and the one or more user profiles; and
select, according to a classification responsive to the application of the one or more rules, which one type of a plurality of types of prohibited transactions correspond to the one or more of the aggregated transactions.

11. The prohibited transaction classification system of claim 10, wherein the one or more processors are configured to:
receive, from a first fiat service provider, a first portion of the fiat transaction data and user account data;
receive, from a second fiat service provider, a second portion of the fiat transaction data and user account data; and
generate, according to a data mapping between the first fiat service provider and the second fiat service provider, a normalized instance of the fiat transaction data and user account data, wherein the classification uses the normalized instance.

12. The prohibited transaction classification system of claim 10, wherein the one or more processors are configured to:
dynamically generate the query function using a current set of search terms and token variants.

13. The prohibited transaction classification system of claim 10, wherein the one or more processors are configured to:
receive, from a plurality of control elements of a user interface, a selection of constituent elements of the aggregated transactions, the one or more users, and accounts for the account data;
present a level of risk, via a user interface, the presentation comprising the classification and a further plurality of classifications of a further plurality of aggregated transactions based on the selected ones of the aggregated transactions, the one or more users, and accounts, wherein:
different of the plurality of types of prohibited transactions are presented according to a different color, level, or prominence; and
like types of the plurality of types of prohibited transactions are co-located.

14. The prohibited transaction classification system of claim 10, wherein the one or more processors are configured to:
classify a second one or more of the aggregated transactions as none of the plurality of types of prohibited transactions.

15. The prohibited transaction classification system of claim 14, wherein the one or more processors are configured to:
classify a third one or more of the aggregated transactions as a second of the plurality of types of prohibited transactions.

16. The prohibited transaction classification system of claim 10, wherein the one or more processors are configured to:
present, based on the classified type of prohibited transaction, a risk recommendation.

17. The prohibited transaction classification system of claim 10, wherein the one or more processors are configured to:
automatically perform, based on the classified type of prohibited transaction, a predefined set of actions correspond to the classified type of prohibited transaction.

18. The prohibited transaction classification system of claim 10, wherein the plurality of types of prohibited transactions correspond to:
identity theft;
a total value of the one or more one or more VASP-related transactions exceeding a threshold;
romance scams; and
elder abuse.

19. A non-transitory computer-readable media comprising computer-readable instructions stored thereon that, when executed by at least one processor of a data processing system, cause the at least one processor to:
dynamically generate a query function using search terms to identify virtual asset service provider (VASP) related transactions generated based on a detection and retrieval of an updated text corpus received from a predefined data source, wherein dynamically generating the query function comprises detecting an update notification or change event indicating availability of a revised text corpus at the predefined data source, responsive to which the data processing system regenerates the query function;
identify one or more of the search terms and one or more user profiles of one or more users, based on user account data;
search, using the identified search terms, fiat transaction data of one or more fiat service providers to identify one or more VASP-related transactions including the one or more fiat service providers;
aggregate transactions of the fiat transaction data matching the identified search terms for each user of the one or more user profiles;
determine, for each user profile, a plurality of metrics of the aggregated transactions, the plurality of metrics corresponding with the one or more VASP-related transactions;
apply, by a rules engine, one or more rules to the plurality of metrics of the aggregated transactions and the one or more user profiles; and
select, according to a classification responsive to the application of the one or more rules, which one type of a plurality of types of prohibited transactions correspond to the one or more of the aggregated transactions.

20. The computer-readable media of claim 19, further comprising instructions to cause the at least one processor to:
receive, from a first fiat service provider, a first portion of the fiat transaction data and user account data;
receive, from a second fiat service provider, a second portion of the fiat transaction data and user account data; and
generate, according to a data mapping between the first fiat service provider and the second fiat service provider, a normalized instance of the fiat transaction data and user account data, wherein the classification uses the normalized instance.
